(19) United States
(12) Patent Application Publication
(10) Pub. No.: US 2005/0204155 A1
(43) Pub. Date: Sep. 15, 2005

(54) Tamper resistant secure architecture

(75) Inventors: Srivaths Ravi, (US); Anand Raghunathan, (US); Srimat T. Chakradhar, (US)

Correspondence Address: SUGHRUE MION, PLLC, 2100 PENNSYLVANIA AVENUE, N.W., SUITE 800, WASHINGTON, DC, 20037, US

(73) Assignee: NEC LABORATORIES AMERICA, INC

(21) Appl. No.: 10/795,385

(22) Filed: Mar. 9, 2004

(51) Int. Cl. H04L 9/00

(52) U.S. Cl. 713/200

(57) ABSTRACT

A system comprising at least one host processor, at least one security processor and a first memory that is exclusively accessible only by the security processor.

### I. DESCRIPTION

I.A. Field

The present disclosure teaches techniques related to a tamper resistant secure architecture.

I.B. Background

A secure architecture should desirably address requirements of a multi-processor architecture, while providing a clear value. A secure architecture should also desirably achieve safety, privacy, and integrity of the cryptographic computations. Specifically, the following features are particularly desirable
The security processor is always guaranteed to run only trusted code.
All on-chip and off-chip resources (e.g., memory) used for the purpose of security processing are exclusively accessible only to the security processor.
Applications running on the processors should be able to use the security processor for performing cryptographic functions without the processors ever having to have direct access to the key used.

In addition the architecture should desirably satisfy some practical considerations as follows:
The security processor should be modular, so that it can be disabled without affecting the functioning of the rest of the system.
The secure architecture should be non-intrusive into the mobile terminal SW development process, and allow the seamless execution of applications that do not require the use of the security processor (e.g., legacy or third-party applications).
Due to cost/area limitations, the on-chip hardware and memory requirements of the security processor should be minimized.
Finally, the architecture should have system-level flexibility, i.e., avoid hardwiring features in the chip. For example, the security firmware image and the security processor's working area in the off-chip data memory should be re-locatable in the FlashROM and SDRAM, respectively.

### II. SUMMARY

It will be significantly advantageous to provide a security processor that provides some of the features noted above.

This disclosure teaches a system comprising at least one host processor, at least one security processor and a first memory that is exclusively accessible only by the security processor.

Specifically, the security processor is a programmable processor associated with an instruction set.

In another specific enhancement, the system further comprises a bus monitor that monitors a bus connecting the host processor and the security processor.

More specifically, the bus monitor regulates interactions between components connected to the bus.

Still more specifically, at least the host processor, the security processor and the first memory form part of a system-on-chip and the components include at least one off-chip component.

Even more specifically, the components include a memory.

Even more specifically, the components include at least one peripheral.

In another specific enhancement, at least one of the functionalities provided by the bus monitor is implemented within a bus controller.

In another specific enhancement, the security processor does not execute any functionality unrelated to security processing.

More specifically, the system further comprises a second memory, a subset of the second memory being accessible to at least one of said host processor and said security processor.

More specifically, the second memory includes a security image corresponding to the security processor.

Even more specifically, the security image includes a control block and firmware.

Even more specifically, the control block is encrypted.

Even more specifically, the security image further includes hash values corresponding to the control block and the firmware.

In another specific enhancement the second memory includes a data memory.

In another specific enhancement, the second memory includes a secondary storage.

More specifically, the second memory is partitioned into two or more subsets, and at least one of the said subsets is off-chip.

In another specific enhancement, security code is located in the first memory.

More specifically, the security code includes a bootloader for security processing.

In another specific enhancement, security data is located in the first memory.

More specifically, the security data includes keys for encrypting or decrypting code or data stored in the second memory.

More specifically, keys for decrypting code or data are located in the second memory.

In another specific enhancement, the bus monitor ensures that a subset of the second memory is accessible only to the security processor.

In yet another specific enhancement, the system is a mobile communication device.

More specifically, the mobile communication device is a wireless telephone.

Another aspect of the disclosed teachings is a method of operating a security processor, the method comprising booting up the security processor when a system is powered up. A wait state is entered into on successful booting, where the security processor receives security processing tasks from at least one other processor. A security processing task is executed. An exception state is entered into if a security violation is detected at any time.

In a specific enhancement during booting a secure boot loader is executed, said boot loader validates a firmware.

In another specific enhancement, the booting is performed using a sub-process including reading a location containing start address of a security image. A control block is authenticated. A bus monitor is initialized. A firmware is authenticated. If errors are detected, a security exception is entered into.

More specifically, during authentication of the control block a computed hash value of the control block is compared against a stored hash value.

More specifically, during authentication of the control block at least one subset of the control block is decrypted.

More specifically, during authentication of the firmware a hash value of the firmware is computed and compared against a stored hash value of the firmware.

More specifically, during authentication of the firmware at least one subset of the firmware is decrypted.

Even more specifically, if a hash error is detected the security exception state is entered into.

Even more specifically, if a hash error is detected the security exception state is entered into.

More specifically, if an error occurs in initializing the bus monitor, a security exception state is entered into.

In another specific enhancement, during the security exception state, secure memories are reset and an off state is entered into, wherein a system reset or a power on is required to take the security processor out of the off state.

In yet another specific enhancement, on initialization the monitor ensures that only the security processor can handle bus transactions involving addresses that are part of protected memory areas.

In yet another specific enhancement, during the security exception state, the security processor disables operation of all other processors.

In yet another specific enhancement, during the security exception state, the security processor disables all other processors from accessing a memory.

### III. BRIEF DESCRIPTION OF THE DRAWINGS

The disclosed teachings will become more apparent by describing in detail examples and embodiments thereof with reference to the attached drawings in which:

FIG. 1 is an exemplary implementation of an architecture embodying some aspects of the disclosed teachings.

FIG. 2 depicts a state diagram that describes operation of the architecture shown in FIG. 1.

FIG. 3 depicts a state diagram for a secure boot process for the example architecture of FIG. 1.

FIG. 4 depicts a state diagram that shows how security exceptions are handles in the architecture of FIG. 1.

FIG. 5 illustrates a comparison of the example secure architecture with an architecture in the related art.

### IV. DETAILED DESCRIPTION

IV.A. Example Implementation

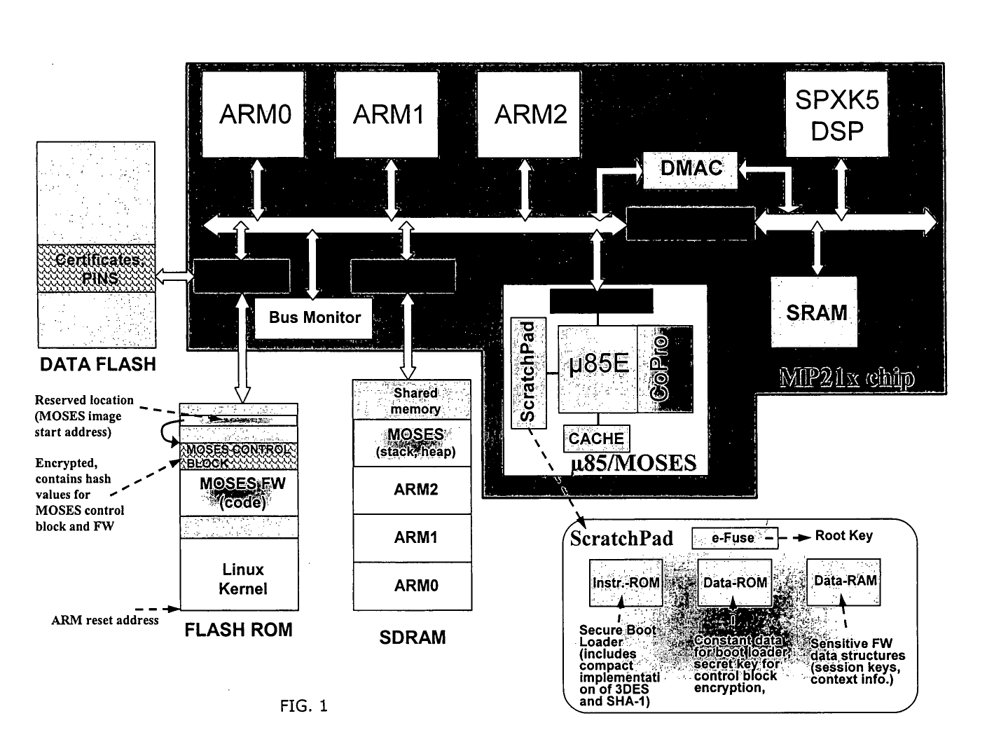

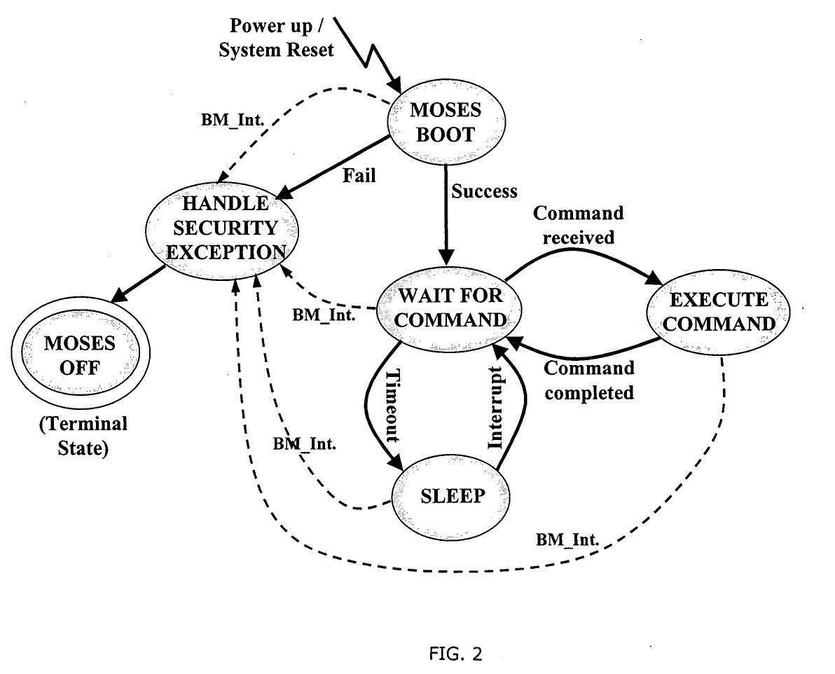

FIG. 1 shows an example implementation of an architecture that achieves several of the desirable features noted. It should be noted that though several specific hardware/software components are shown in example, the teachings are not limited to these specific hardware/software components. The example secure architecture includes a combination of the following features:
All security processing is performed on a dedicated security processor (u85/MOSES, in the shown example), which does not execute any user applications (e.g., downloaded binaries).
The security image in the FlashROM is divided into two parts—a control block (for example a MOSES control block), and the firmware (for example, MOSES firmware). The control block is encrypted (using a symmetric key), and contains the expected hash values for both the control block itself, and the firmware.
Sensitive code and data, such as the bootloader (for example the MOSES bootloader), and critical data structures used in the firmware, are stored in the on-chip scratchpad.
The Bus monitor ensures that only the security processor can access the reserved areas in off-chip memory, such as the FlashROM and SDRAM. The bus monitor is initialized and activated by the bootloader, based on data stored in the control block.

IV.B. Example of an Operation of the Secure Architecture

FIG. 2 shows an example of an overall state diagram that describes the operation of the example security processor (u85/MOSES) shown in FIG. 1.

1. Boot state: The security processor boots upon power up or system reset, i.e., hardware or software triggered reset of the entire chip (called the MOSES BOOT state in the exemplary implementation). In this state the security processor executes a secure boot loader from the instruction ROM that is part of the on-chip scratchpad, which culminates in the validation (authentication) of the firmware (MOSES firmware) in the FlashROM. Note that power up/system reset is independent of other processors (for example, ARMs or DSP) on the chip. This ensures that no custom OS image modifications are required on any other processors (ARM processors) to boot the security processor.

2. WAIT FOR COMMAND state: Upon successful boot, the processor enters a WAIT FOR COMMAND state, in which it is ready to receive offloaded security processing operations from any of the processors in the chip. If a command is received in this state, the security processor transitions to the EXECUTE COMMAND state.

3. EXECUTE COMMAND state: In this state, the requested security function is executed. After completion of the command, control returns to the WAIT FOR COMMAND state after completion.

4. SLEEP state: In order to reduce power consumption, the security processor will enter a SLEEP state upon completion of a timeout (a minimum period for which no command was received). From the SLEEP state, if an interrupt is received, u85/MOSES will transition back into the WAIT FOR COMMAND STATE.

5. SECURITY EXCEPTION state: If the secure boot loader fails to verify the integrity of the control data or the firmware in FlashROM, or if the bus monitor detects an illegal access at any time (BM-Int), the security processor transitions into the HANDLE SECURITY EXCEPTION state, in which the secure memory areas are reset, before going into an OFF state (the MOSES OFF state in the exemplary implementation). The OFF state is a terminal state, i.e., once the security processor reaches this state, only a power off/on, or system reset can take it out of this state.
1. Boot State

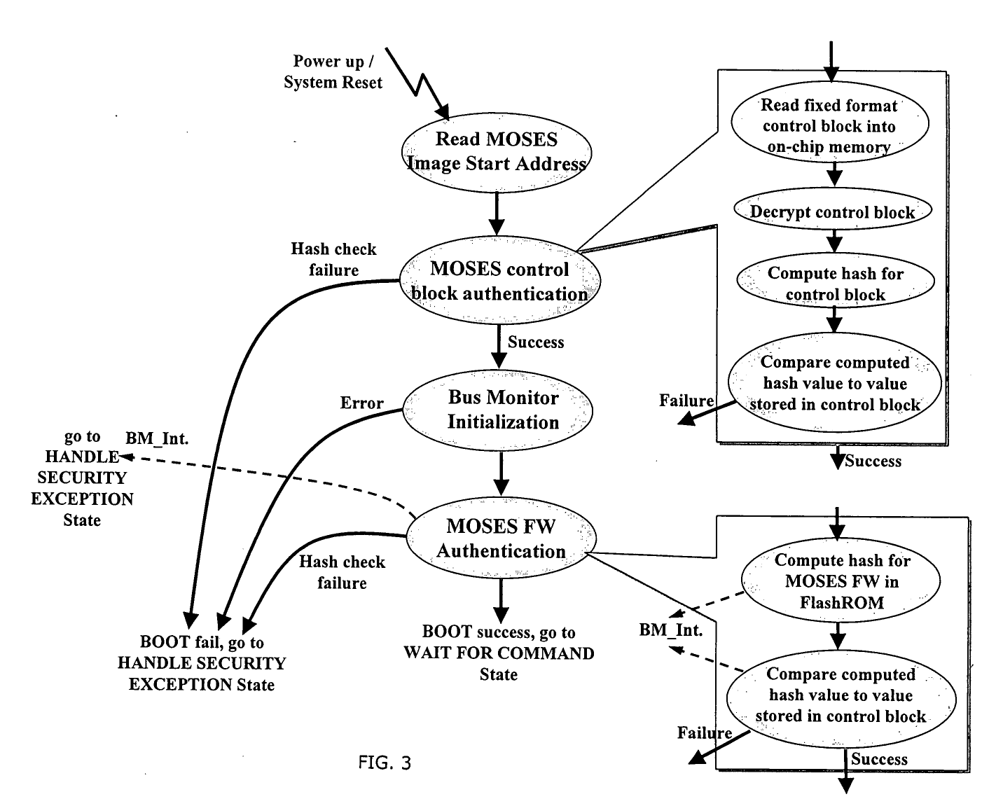

The BOOT state (secure bootloader) is described in greater detail in with the state diagram shown in FIG. 3. The steps performed in this state are described below.

a. Image Start Address: In addition to initializing the processor state, the secure boot loader first reads the fixed (hardwired) location that contains the starting address of the security processor image in FlashROM.

b. Control block authentication: The bootloader then reads the control block from the FlashROM, decrypts it (using a compact 3DES symmetric key description routine that is part of the bootloader itself), and stores the decrypted control block into the Data RAM in the on-chip scratchpad. The control block contains various fields, including the values to be written to the Bus Monitor registers, and hash values for the control block itself, as well as the firmware. The boot loader computes the hash value for the decrypted control block (using a compact SHA-1 routine that is part of the bootloader itself), and compares it with the expected value stored in the control block itself. If the values do not match, the boot process has failed, and security processor then transitions into the HANDLE SECURITY EXCEPTION state.

c. Bus monitor initialization: Once the control block has been authenticated, the security processor initializes the Bus Monitor registers with the data provided in the control block, and activates the Bus Monitor. Once the bus monitor is active, it provides hardware protection to the specified areas in the FlashROM and SDRAM, by ensuring that only the security processor can execute bus transactions to addresses corresponding to the protected areas.

d. FW Authentication: Next, the security processor performs authentication of the firmware stored in FlashROM. The hash value of the firmware is computed using the compact SHA-1 routine that is part of the bootloader. The computed hash value is compared to the expected hash value stored in the control block. Once again, if the hash values do not match, the boot process has failed and the security processor transitions into the HANDLE SECURITY EXCEPTION STATE.
2. Security Exception Handling

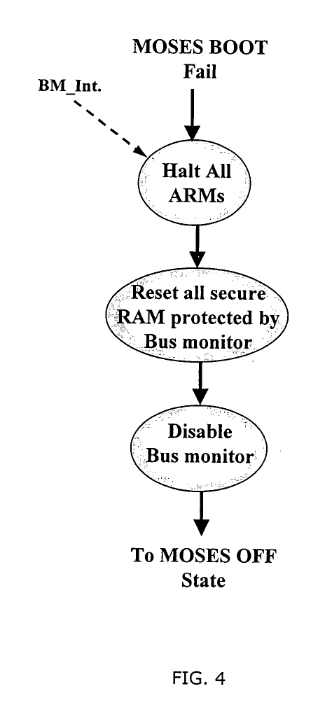

An example operation of the security processor in the HANDLE SECURITY EXCEPTION state is described in FIG. 4. In this state, the security processor first disables the operation of all the other processors. This could be implemented either through a hardware interrupt to the other processors that causes the processors to execute halt instructions, or by directly controlling the clock fed to the other processors.

This step is taken to ensure that subsequent bus transactions generated from security processor when it resets the secure memory areas are not blocked due to bus conflicts. If this step is not performed, depending on exactly how the Bus Monitor is implemented, malicious software running on the other processors (ARM processors in the example implementation) has a small window of time during which it may be able to access secure memory areas. Once the other processors are disabled, the security processor resets all the writeable secure memory areas that are protected by the Bus Monitor. The next step is the disable the Bus Monitor, after which the security processor transitions into the OFF state.

IV.C. Hardware Components

The example implementation of the architecture includes the following hardware components:
1. On-chip Scratchpad:

The Instr. ROM should be large enough to store the secure boot loader, which includes compact implementations of 3DES and SHA-1 It is believed that an estimate 6 kB of on-chip ROM should be sufficient to store the boot loader.

The Data RAM should be large enough to store the sensitive key management data structures of the firmware (for example, CGX software). The additional overhead for storing the control block is quite minimal (few tens of Bytes)
2. Co-processor Hardware:

In order to enable very compact (small code size) implementations of 3DES and SHA-1, very large portions of the algorithms must be offloaded to HW as co- processor instructions. This is estimated to add an additional 5K gates (in addition to the co-processor instructions already designed for accelerating CGX functions).
3. Reserved location in FlashROM:

In order to allow relocatability of the firmware image in FlashROM, it is desirable to reserve one location in FlashROM. This should facilitate mobile terminal developers to easily customize and create FlashROM images. This location should contain the actual starting address of the security processor image. This address is hardwired in the secure bootloader, i.e., in on-chip ROM, hence, it should be fixed when the chip is designed. This is similar to the requirement of the processors to have a reset to a reserved location, e.g., 0x0.
4. Secret Key for Encrypting MOSES Control Block

A symmetric (3DES) key is used to encrypt and decrypt the control block in the FlashROM. One option is to use the Root Key (e-Fuse) for this purpose. However, this has two major disadvantages: (i) the FlashROM image will be different from one mobile terminal to another, making it difficult to restore the FlashROM (for maintenance/repair), and (ii) the Root Key for each chip (each fabricated instance) must be separately maintained in a database by NEC-EL, and provided to customers, who will then use these keys to create the FlashROM images that will work for each chip. These overheads in cost and effort may not be acceptable to mobile terminal developers. Hence, a separate symmetric key stored in the Data ROM of the on-chip scratchpad is provided. This is used for the encryption of the MOSES control block. This symmetric key need not be unique to each mobile terminal—it could be fixed for all the chips provided to each customer, or could be varied for each “batch” of chips.
5. Bus Monitor

A minimum of 8 entries in the bus monitor that can be programmed by the security processor should be sufficient. Each entry should contain at least a start address, end address, allowed bus master ID (that indicate which bus master can access the specified address range), and (two) mode bits (that separately indicate whether read or write access is allowed).
6. The Security Processor Interrupts

The interrupt generated by the bus monitor when it detects an illegal access should be a non-maskable interrupt (NMI). In addition, a “security processor off” interrupt can be used to allow the other processors to explicitly turn off the security sub-system. Finally, a “wake up” interrupt is required to restore the security processor from the “SLEEP” state.
7. Mechanism to Temporarily Disable Other Processors

When the security processor is in the HANDLE SECURITY EXCEPTION STATE, it resets the secure areas in SDRAM over the system (AMBA) bus. This is a very critical operation. Hence, it is desirable to ensure that, during this period, the other processors cannot generate bus transactions (to either block the security processor from performing the reset operation, or to read values in secure memory areas before the reset is performed). This can be achieved either through an interrupt (preferable non-maskable) generated by the security processor to all the other processors, which blocks their execution until the security processor has completed the reset operation.
8. State Bit to Maintain MOSES On/Off State Bit

It may be desirable to allow software running on the other processors the ability to turn off the entire security sub-system (including the security processor and the Bus Monitor). This will require a bit of hardware storage that is set only at power up or system reset. This state bit is reset when the security processor enters the OFF state.

IV.D. Comparison with a Related Architecture

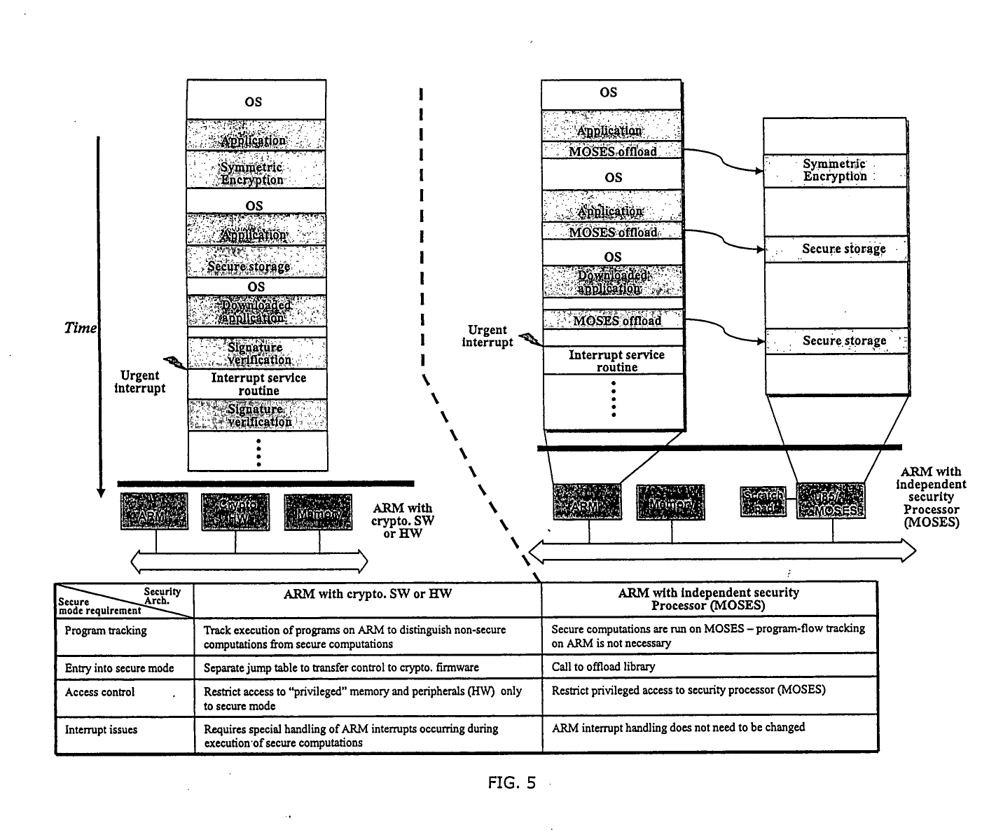

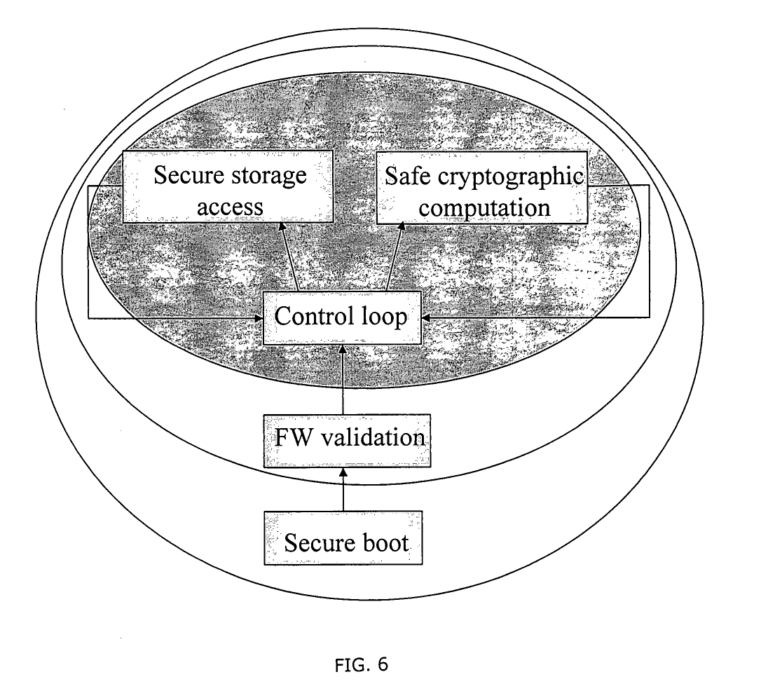

The disclosed architecture has several unique characteristics that can be exploited to efficiently implement a secure architecture. FIG. 5 shows a schematic comparison of the disclosed exemplary implementation and an architecture in the related art.

In the related architecture, the CPU has to execute both non-security functionality (OS, applications), as well as sensitive security computations. In the disclosed architecture, however, all sensitive cryptographic operations are offloaded to the security processor. As a result, differences in terms of secure mode requirements are as follows:
1. Program Tracking:

Implementing secure mode on a related architecture (for example, Safenet or Discretix that use ARM with HW Security IP, or ARM TrustZone) requires close tracking of the program flow on the host CPUs, in order to distinguish between secure and non-secure computations. In the disclosed architecture, there is a natural physical (spatial) boundary since the secure computations are performed on a separate processor.
2. Entry into Secure Mode

The disclosed offload library based approach eliminates the need for a jump table that forms the entry point into security related computations.
3. Access Control

Access to restricted resources (secure areas in SDRAM, master key, etc) can be simply restricted to the security processor, without worrying about changing access control based on the current execution state of the CPU of the other processor.
4. Interrupt Processing on the Other Processors

When the CPU of the other processors perform both secure and non-secure operations, it is necessary to design special interrupt handling routines that are invoked when an interrupt occurs during secure mode. Further, it may be necessary to explicitly save and restore the context of the security firmware. In addition to requiring SW development effort and changes to OS code, this introduces a performance penalty. In the case of the disclosed architecture, this is avoided, since ARM computations can be interrupted at any time without compromising security. It will be necessary to disable interrupts only for a small segment of code inside the offload functions.

Other modifications and variations to the invention will be apparent to those skilled in the art from the foregoing disclosure and teachings. Thus, while only certain embodiments of the invention have been specifically described herein, it will be apparent that numerous modifications may be made thereto without departing from the spirit and scope of the invention.

1. A system comprising:
at least one host processor;
at least one security processor; and
a first memory that is exclusively accessible only by the security processor.

2. The system of claim 1, wherein the security processor is a programmable processor associated with an instruction set.

3. The system of claim 1, wherein the system further comprises a bus monitor that monitors a bus connecting the host processor and the security processor.

4. The system of claim 3, wherein the bus monitor regulates interactions between components connected to the bus.

5. The system of claim 4, wherein at least the host processor, the security processor and the first memory form part of a system-on-chip and the components include at least one off-chip component.

6. The system of claim 4, wherein the components include a memory.

7. The system of claim 4, wherein the components include at least one peripheral.

8. The system of claim 3, wherein at least one of the functionalities provided by the bus monitor is implemented within a bus controller.

9. The system of claim 1, wherein the security processor does not execute any functionality unrelated to security processing.

10. The system of claim 5, further comprising a second memory, a subset of the second memory being accessible to at least one of said host processor and said security processor.

11. The system of claim 10, wherein the second memory includes a security image corresponding to the security processor.

12. The system of claim 11, wherein the security image includes a control block and firmware.

13. The system of claim 12, wherein the control block is encrypted.

14. The system of claim 12, wherein the security image further includes hash values corresponding to the control block and the firmware.

15. The system of claim 10, wherein the second memory includes a data memory.

16. The system of claim 10, wherein the second memory includes a secondary storage.

17. The system of claim 10, wherein the second memory is partitioned into two or more subsets, and at least one of the said subsets is off-chip.

18. The system of claim 1, wherein security code is located in the first memory.

19. The system of claim 18, wherein the security code includes a bootloader for security processing.

20. The system of claim 1, wherein security data is located in the first memory.

21. The system of claim 20, wherein the security data includes keys for encrypting or decrypting code or data stored in the second memory.

22. The system of claim 10, wherein keys for decrypting code or data are located in the second memory.

23. The system of claim 10, wherein the bus monitor ensures that a subset of the second memory is accessible only to the security processor.

24. The system of claim 1, wherein the system is a mobile communication device.

25. The system of claim 24, wherein the mobile communication device is a wireless telephone.

26. A method of operating a security processor, the method comprising:
a. booting up the security processor when a system is powered up;
b. entering a wait state on successful booting, where the security processor receives security processing tasks from at least one other processor;
c. executing a security processing task; and
d. entering an exception state if a security violation is detected at any time.

27. The method of claim 26, wherein during booting a secure boot loader is executed, said boot loader validates the firmware.

28. The method of claim 26, wherein the booting is performed using a sub-process including:
i. reading a location containing start address of a security image;
ii. authenticating a control block;
iii. initializing a bus monitor; and
iv. authenticating a firmware,
wherein if errors are detected, a security exception is entered into.

29. The method of claim 28, wherein during authentication of the control block a hash value of the control block is compared against a stored hash value.

30. The method of claim 28, wherein during authentication of the control block at least one subset of the control block is decrypted.

31. The method of claim 28, wherein during authentication of the firmware a hash value of the firmware is computed and compared against a stored hash value of the firmware.

32. The method of claim 28, wherein during authentication of the firmware at least one subset of the firmware is decrypted.

33. The method of claim 29, wherein if a hash error is detected the security exception state is entered into.

34. The method of claim 31, wherein if a hash error is detected the security exception state is entered into.

35. The method of claim 28, wherein if an error occurs in initializing the bus monitor, a security exception state is entered into.

36. The method of claim 29, wherein during the security exception state, secure memories are reset and an off state is entered into, wherein a system reset or a power on is required to take the security processor out of the off state.

37. The method of claim 29, wherein on initialization the monitor ensures that only the security processor can handle bus transactions involving addresses that are part of protected memory areas.

38. The method of claim 29, wherein during the security exception state, the security processor disables operation of all other processors.

39. The method of claim 29, wherein during the security exception state, the security processor disables all other processors from accessing a memory.
